(19) United States
(12) Patent Application Publication
(10) Pub. No.: US 2014/0282799 A1
(43) Pub. Date: Sep. 18, 2014

(54) METHOD FOR TRANSMITTING MEDIA DATA VIA A HETEROGENEOUS IP NETWORK INDEPENDENTLY OF A MEDIA CODEC

(71) Applicant: Electronics and Telecommunications Research Institute, Daejeon (KR)

(72) Inventor: Seong Jun Bae, Daejeon (KR)

(73) Assignee: Electronics and Telecommunications Research Institute, Daejeon (KR)

(21) Appl. No.: 14/351,776

(22) PCT Filed: Oct. 12, 2012
(86) PCT No.: PCT/KR2012/008337

§ 371 Date: Apr. 14, 2014

(30) Foreign Application Priority Data
Oct. 13, 2011 (KR) 10-2011-0104853
Oct. 10, 2012 (KR) 10-2012-0112544

(51) Int. Cl. H04L 29/06; H04N 21/236

(52) U.S. Cl. CPC H04L 65/601; H04N 21/236
USPC 725/116

(57) ABSTRACT

The present invention relates to a method for transmitting media data via a heterogeneous IP network, the method efficiently transmitting, independently of a specific media codec, media streaming in the format of a coded media fragment data unit, including a header of a media unit having a minimized size and a simplified structure.

### CROSS-REFERENCE TO RELATED APPLICATION

This application claims priorities to Korean Patent Application No. 10-2011-0104853 filed on Oct. 13, 2011 and Korean Patent Application No. 10-2012-0112544 filed on Oct. 10, 2012, the contents of which are herein incorporated by reference in its entirety.

### TECHNICAL FIELD

The present invention relates to a method of transporting media data and, more particularly, to a method of transporting coded media data in a system for transporting coded media data via a heterogeneous IP network.

### BACKGROUND ART

An MPEG-2 system is a standard for functions such as packetization, synchronization, multiplexing, and the like, required for transmitting audio/video (A/V) contents in a broadcasting network, and an MPEG-2 TS (Transport Stream) technique has been standardized and currently widely used. However, the MPEG-2 TS is ineffective in a new environment in which networks are all adapted for IP (Internet Protocol).

Thus, a novel media transport technique in a system for transporting coded media data via a heterogeneous IP network in consideration of a new media transport environment and an anticipated media transport environment is required.

### DISCLOSURE

### Technical Problem

In the system for transporting coded media data via a heterogeneous IP network, if a header of a media unit, a portion accessed and processed by a media encoder, rather than a portion processed by the system, has a complicated structure, implementation is difficult and availability may be degraded.

Therefore, an object of the present invention is to provide a method of transporting media data via a heterogeneous IP network in order to effectively transmit media streaming such that it is not dependent upon a particular media codec.

### Technical Solution

According to an aspect of the present invention, there is provided a method of transporting coded media data in a system for transporting coded media fragment data via a heterogeneous IP network in order to transport coded media data, including: receiving a media unit (MU) having a format independent on a particular media codec from a media codec layer; generating an MMT asset by encapsulating the generated media unit; generating an MMT package by encapsulating the generated MMT asset; generating an MMT payload format upon receiving the generated MMT package; and generating an MMT transport packet upon receiving the generated MMT payload format, wherein the media unit includes a header part and a data part, the data part includes coded media fragment data, and the header part includes an indicator indicating whether or not the coded media fragment data includes a random access point, an indicator indicating whether or not the coded media fragment data includes a start portion of coded media data, and an indicator indicating whether or not the coded media fragment data includes a final portion of the coded media data.

The header part may further include an indicator indicating whether or not the coded media fragment data requests lossless transmission.

The receiving of the MU having a format independent on a particular media codec from the media codec layer may be receiving a media processing unit (MPU) having a format independent on a particular media codec from the media codec layer, and the generating of an MMT asset by encapsulating the generated MU may be generating an MMT asset by encapsulating the generated MPU.

The receiving of the MPU having a format independent on a particular media codec from the media codec layer may include: receiving a media fragment unit (MFU) having a format independent on a particular media codec from the media codec layer; and generating an MPU by encapsulating the MFU.

The header part may include an indicator indicating whether or not the coded media fragment data includes a random access point, an indicator indicating whether or not the coded media fragment data includes a start portion of an access unit (AU), and an indicator indicating whether or not the coded media fragment data includes a final portion of the AU.

### Advantageous Effects

According to embodiments of the present invention, in case of an MMT (MPEG Media Transport) system, a header of a media unit, accessed and processed by a media encoder, rather than a portion processed by the system, is configured to have minimum information that can be provided by the media encoder, whereby the size of the header of the media unit transferring information that can be obtained during a media encoding process can be minimized and a structure of the media unit header can be simplified.

Also, the header of the media unit is configured to have “general” information that can help transport and consume media, thus simply implementing the media unit.

In addition, since the header of the media unit is configured to have information transmitted by the media encoder to the system, excluding information dependent upon a particular media codec, the system for transporting media data coded irrespective of a media codec via a heterogeneous IP network can more effectively perform media streaming.

### DESCRIPTION OF DRAWINGS

FIG. 1 is a conceptual view illustrating an MMT layer structure.

FIG. 2 is a conceptual view illustrating a format of unit information (or data or a packet) used for each layer of the MMT layer structure;

FIG. 3 is a conceptual view of a configuration of an MMT package.

FIG. 4 is a table showing a media fragment unit (MFU) according to an embodiment of the present invention;

FIG. 5 is a table showing a header of the MFU according to an embodiment of the present invention;

FIG. 6 is a flow chart illustrating a method of transporting coded media divided data according to an embodiment of the present invention;

FIG. 7 is a flow chart illustrating a method of transporting coded media divided data according to another embodiment of the present invention; and

FIG. 8 is a flow chart illustrating a method of transporting coded media divided data according to still another embodiment of the present invention

### BEST MODES

The present invention may be embodied in many different forms and may have various embodiments, of which particular ones will be illustrated in drawings and will be described in detail.

However, it should be understood that the following exemplifying description of the invention is not meant to restrict the invention to specific forms of the present invention but rather the present invention is meant to cover all modifications, similarities and alternatives which are included in the spirit and scope of the present invention.

While terms such as “first” and “second,” etc., may be used to describe various components, such components must not be understood as being limited to the above terms. The above terms are used only to distinguish one component from another. For example, a first component may be referred to as a second component without departing from the scope of rights of the present invention, and likewise a second component may be referred to as a first component.

When a component is mentioned as being “connected” to or “accessing” another component, this may mean that it is directly connected to or accessing the other component, but it is to be understood that another component may exist therebetween. On the other hand, when a component is mentioned as being “directly connected” to or “directly accessing” another component, it is to be understood that there are no other components in-between.

In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

The terminology used herein is for the purpose of describing particular embodiments only and is not intended to be limiting of the invention. Unless otherwise defined, all terms used herein have the same meaning as commonly understood by one of ordinary skill in the art to which this invention pertains, and should not be interpreted as having an excessively comprehensive meaning nor as having an excessively contracted meaning. If technical terms used herein is erroneous that fails to accurately express the technical idea of the present invention, it should be replaced with technical terms that allow the person in the art to properly understand. The general terms used herein should be interpreted according to the definitions in the dictionary or in the context and should not be interpreted as an excessively contracted meaning.

Hereinafter, terms are defined to have meanings as follows.

A system for transporting coded media data via a heterogeneous IP network is referred to as an MMT (MPEG Media Transport) system.

A content component or media component is defined as a single type of media or a subset of a single type of media, and may be, for example, a video track, movie subtitles, or an enhancement layer of video.

Content is defined as a set of content components, and may be, for example, movie, song, and the like.

Presentation is defined as an operation performed one or more devices to allow a user to experience one or content component or service (e.g., seeing movie).

Service is defined as one or more content components transmitted for presentation or storage.

Service information is defined as meta data describing one service and characteristics and components of the service.

Access unit (AU) is the smallest data entity, having time information as an attribute.

When coded media data without designated time information for decoding and presentation is related, AU is not defined.

MMT asset is a logical data entity configured as at least one MPU along with the same MMT asset ID or configured as a particular data mass together with a format defined in a different standard. The MMT asset is the largest data to which the same composition information and transmission characteristics are applied.

MMT asset delivery characteristics MMT-ADC is description related to a QoS request for delivering an MMT asset. MMT-ADC is expressed such that a particular transmission environment cannot be known.

MMT composition information (MMT CI) describes spatial and temporal relationships between MMT assets.

A media fragment unit (MFU) is a general container, which is independent to any particular codec and accommodates coded media data that can be independently consumed by a media decoder. The MMT CI, having a size smaller than or equal to an AU, accommodates information that can be used in a transport layer

MMT package is a collection of logically structured data, which is comprised of at least one MMT asset, MMT-composition information, MMT-asset transmission characteristics, and descriptive information.

MMT packet is a data format generated or consumed by an MMT protocol.

The MMT payload format is a format for an MMT package to be transferred by an MMT protocol or an Internet application layer protocol (e.g., an RTP), or payload of an MMT signaling message.

Media processing unit (MPU) is a general container independent to any particular media codec, which accommodates information related to at least one AU and additional transmission and consumption. For non-timed data, MPU accommodates a part of data not belonging to an AU range. The MPU is coded media data that can be completely and independently processed. In this context, processing refers to encapsulation or packetization into an MMT package for a transmission.

Non-timed data defines every data element consumed without specified time. Non-timed data may have a time range in which data may be executed or started.

Timed data defines a data element related to a particular time for decoding and presentation.

Media data refers to a data element including non-timed data and timed-data.

Media unit refers to a container including a media fragment unit (MFU) or a media processing unit (MPU).

Hereinafter, embodiments of the present invention will be described in detail with reference to the accompanying drawings. In describing embodiments of the present invention, the same reference numbers are used for the same elements for overall understanding, and a repeated description of the same elements will be omitted.

FIG. 1 is a conceptual view illustrating an MMT layer structure.

Referring to FIG. 1, an MMT layer includes an encapsulation layer, a delivery layer, and an S layer. The MMT layer operates above a transport layer.

The encapsulation layer (E-layer) may serve to perform functions, for example, such as media packetization, fragmentation, synchronization, multiplexing, and the like.

The encapsulation functional area defines a logical structure of a format of data units to be processed by an entity that follows MMT, an MMT package, and media contents. In order to provide information essential for adaptive transmission, an MMT package specifies components including media contents and a relationship therebetween. A format of data units is defined to encapsulate coded media such that it is stored or transmitted in payload of a transport protocol and such that it is easily converted therebetween.

As illustrated in FIG. 1, the E-layer may be comprised of an MMT E.1 layer, an MMT E.2 layer, and an MMT E.3 layer.

The E.3 layer generates a media processing unit (MPU) by encapsulating a media fragment unit (MFU) provided from a media codec A layer.

Coded media data from a higher layer is encapsulated into an MFU. A type and a value of coded media may be abstracted such that an MFU can be generally used in a particular codec technique. It allows a lower layer to process an MFU without accessing encapsulated coded media. The lower layer retrieves requested coded media data from a network or a buffer of a repository and transmits it to a media decoder. An MFU has an information media part unit sufficient for performing the operation.

An MFU may have a format that may include a data unit which may be independently consumed in a media decoder and is independent to a particular codec. An MFU may be, for example, a picture or a slice of a video.

One or a group of a plurality of MFUs that can be independently transmitted or decoded generate(s) an MPU. Non-timed media that can be independently transmitted and executed may also generate an MPU. An MPU describes an internal structure such as an arrangement and a pattern of MFUs allowing for a fast access to an MFU and partial consumption.

The E.2 layer generates an MMT asset by encapsulating the MPU generated in the E.3 layer.

The MMT asset, a data entity comprised of one or a plurality of MPUs from a single data source, is a data unit having defined composition information (CI) and transport characteristics (TC). The MMT asset is multiplexed by an MMT payload format and transmitted by an MMT protocol. The MMT asset may correspond to a PES (packetized elementary streams). For example, the MMT asset may correspond to video, audio, program information, an MPET-U widget, a JPEG image, an MPEG 4 file format, an M2TS (MPEG transport stream), and the like.

The E.1 layer generates an MMT package by encapsulating the MMT assent generated by the E.2 layer.

The MMT asset is packaged with MMT composition information (MMT-CI) for a later response of the same user experience separately or together with other functional areas, i.e., a transmission area and a signal area. The MMT package is also packaged together with transmission characteristics for selecting an appropriate transmission method for each MMT asset in order to satisfy quality of experience of an MMT asset.

An MMT package may be comprised of one or a plurality of MMT assets together with additional information such as composition information and transport characteristics. Composition information may include information regarding a relationship between MMT assets, and when one content is comprised of a plurality of MMT packages, it may further include information indicating a relationship between the plurality of MMT packages. Transport characteristics may include delivery characteristics information required for determining a delivery condition of an MMT asset or an MMT packet. For example, the transport characteristics may include a traffic description parameter and a QoS descriptor. The MMT package may correspond to a program of an MPEG-2 TS.

The delivery layer may perform, for example, network flow multiplexing, network packetization, QoS controlling, and the like, of media transmitted via a network.

A delivery functional area defines an application layer protocol and a format of payload. In an embodiment of the present invention, an application layer protocol provides characteristics strengthened to delivery an MMT package, in comparison to the related art application layer protocol for transmission of multimedia including multiplexing. A payload format is defined to deliver coded media data without distinction of a media type or an encoding method.

As illustrated in FIG. 1, a delivery layer (D-layer) may be comprised of an MMT D.1 layer, an MMT D.2 layer, and an MMT D.3 layer.

The D.1 layer generates an MMT payload format upon receiving an MMT package generated in the E.1 layer. The MMT payload format is a payload format for transmitting an MMT asset and transmitting information for consumption according to an MMT application protocol or a different existing application transport protocol such as an RTP. The MMT payload may include a fragment of an MFU together with information such as an AL-FEC.

The D.2 layer generates an MMT transport packet or an MMT packet upon receiving an MMT payload format generated in the D.1 layer. The MMT transport packet or the MMT packet is a data format used for an application transport protocol for an MMT.

The D.3 layer supports QoS by providing a function for exchanging information between layers by a cross-layer design. For example, the D.3 layer may perform QoS control by using a QoS parameter of an MAC/PHY layer.

The S layer performs a signaling function. For example, the S layer may perform a signaling function for a session initialization/control/management of transmitted media, a server-based and/or client-based trick mode, service discovery, synchronization, and the like.

A signaling functional area defines a format of a message for managing delivery and consumption of an MMT package. The message for consumption management may be used to transmit a structure of an MMT package and a message for a delivery management is used to transmit a structure of a payload format and a configuration of a protocol.

As illustrated in FIG. 1, the S layer may be comprised of an MMT S.1 layer and an MMT S.2 layer.

The S.1 layer may perform service discovery, media session initialization/termination, media session presentation/control, an interface function with a delivery (D) layer and (E) layer, and the like. The S.1 layer may define formats of control messages between applications for a presentation session management.

The S.2 layer may define a format of a control message exchanged between delivery end-points of a D layer regarding flow control, delivery session management, delivery session monitoring, error control, and hybrid network synchronization control.

In order to support an operation of a delivery layer, the S.2 layer may include delivery session establishment and release, delivery session monitoring, flow control, error control, resource reservation with respect to a set delivery session, signaling for synchronization under a composite delivery environment, and signaling for adaptive delivery. The S.2 layer may provide signaling required between a sender and a receiver. Namely, the S.2 layer may provide signaling required between a sender and a receiver in order to support an operation of a delivery layer as mentioned above. Also, the S.2 layer may serve to perform an interface function with a delivery layer and an encapsulation layer.

FIG. 2 is a conceptual view illustrating a format of unit information (or data or a packet) used for each layer of the MMT layer structure in FIG. 1;

A media fragment unit (MFU) 130 may include a coded media fragment data 132 and an MFUH (Media Fragment Unit Header) 134. The media fragment unit 130, independent on a particular codec, may have a general container format and include the smallest data unit that can be independently consumed in a media decoder. The MFUH 134 may include additional information such as media characteristics, e.g., loss tolerance. The MFU 130 may be a picture or a slice of a video.

The MFU 130 may define a format for encapsulating a part of an AU in a transport layer in order to perform adaptive transmission within a range of the MFU. The MFU may be used to transmit a certain format of coded media such that a part of an AU may be independently decoded or discarded.

The MFU 130 may have an identifier for discriminating one MFU from other MFUs and have general relationship information between MFUs in a single AU. A dependency relationship between MFUs in a single AU is described, and relevant priority of MFUs may be described as a part of such information. The information may be used to handle transmission in a lower transport layer. For example, a transport layer may omit transmission of MFUs that may be discarded, in order to support QoS transmission in an insufficient bandwidth. Details of the MFU structure will be described later.

An MPU 140 is a set of media fragment units including a plurality of media fragment units 130. The MPU 140 may have a general container format independent on a particular codec, and may include media data equivalent to an access unit. The MPU 140 may have a timed data unit or a non-timed data unit.

The MPU 140 may be a data independently and completely processed by an entity that follows MMT, and the processing may include encapsulation and packetization. The MPU 140 may include at least one MFU or have a part of data having a format defined by a different standard.

A single MPU 140 may accommodate an integral number of at least one AU or non-timed data. For timed data, the AU may be delivered from at least one MFU, but one AU may not be fragmented into a plurality of MPUs. In non-timed data, one MPU accommodates a part of non-timed data independently and completely processed by an entity that follows MMT.

An MPU may be uniquely identified in an MMT package by a sequence number and an associated asset ID discriminating the MPU from a different MPU.

An MPU may have at least one random access point. A first byte of an MPU payload may start by a random access point all the time. In timed data, the foregoing fact means that decoding order of a first MFU in MPU payload is always 0. In timed data, a presentation time and decoding order of each AU may be sent to inform about a presentation time. An MPU may not have an initial presentation time thereof and a presentation time of a first AU of one MPU may be described in composition information. The composition information may specify a first presentation time of an MPU. Details thereof will be described later.

An MMT asset 150 is a set of a plurality of MPUs. The MMT asset 150 is a data entity comprised of a plurality of MPUs (timed or non-timed data) from a single data source, and MMT asset information 152 includes asset packaging metadata and additional information such as a data type. The MMT asset 150 may include, for example, video, audio, program information, an MPEG-U widget, a JPEG image, an MPEG 4 FF (File Format), PES (packetized elementary streams), an M2TS (MPEG transport stream), and the like.

The MMT asset is a logical data entity for accommodating coded media data. The MMT asset may be comprised of an MMT asset header and coded media data. The coded media data may be an aggregational reference group of MPUs with the same MMT asset ID. A type of data that may be individually consumed by an entity directly connected to an MMT client may be considered to be an individual MMT asset. Examples of data types that may be considered to be an individual MMT asset may include MPEG-2 TS, PES, MP4 file, MPEG-U Widget Package, JPEG file, and the like.

Coded media of an MMT asset may be timed data or non-timed data. Timed data is audio visual media data requiring synchronized decoding and presentation of particular data at a designated time. Non-timed data is a type of data that may be decoded at a certain time according to providing of a service or a user interaction and provided.

A service provider may generate a multimedia service by integrating MMT assets and placing the integrated MMT assets in a space-time axis.

An MMT package 160 is a set of MMT assets including one or more MMT assets 150. MMT assets within an MMT package may be multiplexed or concatenated.

The MMT package is a container format for an MMT asset and configuration information. An MMT package provides a repository of the MMT asset and configuration information for an MMT program.

An MMT program provider generates configuration information by encapsulating coded data into MMT assets and describing the MMT assets and a temporal and spatial layout of transmission characteristics thereof. An MU and MMT asset may be directly transmitted by a D.1 payload format. The configuration information may be transmitted by a C.1 presentation session management message. However, an MMT program provider allowing for relay of an MMT program or re-use later and a client may store the message in an MMT package format.

In parsing an MMT package, an MMT program provider determines along which transmission path (e.g., broadcast or broadband) an MMT asset is to be provided to a client. Configuration information in the MMT package is transmitted as a C.1 presentation session management message together with transmission-related information.

Upon receiving the C.1 presentation session management message, the client knows which MMT program is available and how the MMT asset for a corresponding MMT program is to be received.

The MMT package may also be transmitted by a D.1 payload format. The MMT package is packetized by a D.1 payload format and delivered. The client receives the packetized MMT package, configures the entirety or a portion thereof, and here, consumes the MMT program.

Package information 165 of the MMT package 160 may include configuration information. The configuration information may include a list of MMT assets, package identification information, composition information 162, and additional information such as transport characteristics 164. The composition information 162 includes information regarding a relationship between MMT assets 150.

Also, when one content is comprised of a plurality of MMT packages, the composition information 162 may further include information indicating a relationship between the plurality of MMT packages. The composition information 162 may include information regarding a temporal, spatial, and adaptive relationship within the MMT package.

Like information helping transmission and presentation of the MMT package, the composition information in the MMT provides information regarding a spatial and temporal relationship between MMT assets within the MMT package.

An MMT-CI is a descriptive language providing corresponding information by extending HTML5. While HTML5 is designed to describe page-based presentation of text-based contents, the MMT-CI mainly expresses a spatial relationship between sources. In order to support an expression indicating a temporal relationship between MMT assets, the MMT-CI may be extended to have information regarding an MMT asset present in an MMT package like presentation resource, time information for determining transmission and consumption order of an MMT asset, and additional attributes of media elements consuming various MMT assets in HTML5. Details will be described later.

Transport characteristics information 164 includes information regarding transport characteristics, and may provide information required for determining a delivery condition of each MMT asset (or MMT packet). The transport characteristics information 164 may include a traffic description parameter and a QoS descriptor.

The traffic description parameter may include the MFU 130 or bit rate information with respect to the MPU, priority information, and the like. The bit rate information may include, for example, information regarding whether or not an MMT asset is a variable bit rate (VBR) or a constant bit rate (CBR), a guaranteed bit rate with respect to an MFU (or an MPU), and a maximum bit rate with respect to a media fragment unit (MFU). The traffic description parameter may be used for resource reservation between a server, a client, and any other components in a transmission path, and may include, for example, information regarding a maximum size of an MFU (or an MPU) within an MMT asset. The traffic description parameter may be periodically or aperiodically updated.

A QoS describer may include information for controlling QoS, and may include, for example, delay information and loss information. The loss information may include a loss indicator as to whether or not a delivery loss of the MMT asset is allowed or not. For example, when a loss indicator is ‘1’, it may indicate ‘lossless’, and when the loss indicator is ‘0’, it may indicate ‘lossy’. The delay information may include a delay indicator used to discriminate sensitivity of transmission delay of an MMT asset. The delay indicator may indicate whether or not an MMT asset type is conversation, interactive, real time, or non-real time.

One content may include one MMT package. Or, one content may include a plurality of MMT packages.

When one content includes a plurality of MMT packages, composition information or configuration information indicating a temporal, spatial, and adaptive relationship between a plurality of MMT packages may exist within or outside one among MMT packages.

For example, in case of hybrid delivery, some of content components may be transmitted via a broadcast network, and the remainders of the content components may be transmitted via a broadband network. For example, in case of a plurality of AV streams constituting a single multiview service, one stream may be transmitted via a broadcast network and the other stream may be transmitted via a broadband network, and each AV stream may be multiplexed and individually received by and stored in a client terminal. Or, for example, a scenario in which an application software such as widget is transmitted via a broadband network and an AV stream (AV program) is transferred via an existing broadcast network may exist.

In the case of the multiview service scenario and/or widget scenario, the entirety of a plurality of AV streams may become one MMT package, and in this case, one of the plurality of streams may be stored only in one client terminal, storage content may be a part of the MMT package, the client terminal should re-write composition information or configuration information, and the re-written content becomes a new MMT package irrespective of a server.

In the multiview service scenario and/or the widget scenario as mentioned above, each AV stream may become one MMT package, and in this case, a plurality of MMT packages constitute one content are stored in the unit of MMT package in a storage, and composition information or configuration information indicating a relationship between MMT packages is required.

Composition information or configuration information included in one MMT package may refer to an MMT asset within a different MMT package and express the exterior of an MMT package referring to an MMT package in an out-band situation.

Meanwhile, in order to provide information regarding a list of MMT assets 160 provided by a service provider and a path available for transmission of the MMT package 160 to a client terminal, the MMT package 160 may be translated into service discovery information through a control (C) layer, so an MMT control message may include an information table for a service discovery

A server, which has divided multimedia content into a plurality of segments, allocates URL information to the certain number of plurality of segments, stores URL information with respect to the respective segments in a media information file, and transmits the same to a client.

The media information file may be called by various other names such as an ‘MPD (Media Presentation Description)’, a ‘manifest file’, or the like, according to a standardization instrument that standardizes HTTP streaming. Hereinafter, the media information file will be referred to as a media presentation description and described.

Hereinafter, a cross layer interface (CLI) will be described.

A CLI is an interface for exchanging QoS-related information between lower layers including an application layer and a MAC/PHY layer, which provides a means supporting QoS in a single entity. While a lower layer provides bottom-up QoS information such as a network channel state, an application layer provides information related to media characteristics as up-bottom QoS information.

The CLI provides an integrated interface between an application layer and various network layers including IEE802.11 WiFi, IEEE 802.16 WiMAX, 3G, 4G LTE, and the like. Common network parameters of a popular network standard are selected as NAM parameters for static and dynamic QoS control of real-time media application through various networks. The NAM parameter may include a bit error rate value as a BER. The BER may be measured in a PHY or MAC layer. Also, the NAM provides an identifiable bit rate of a lower network, a buffer state, a peak bit rate, a service unit size, and a service data unit loss rate.

Two different methods may be used to provide the NAM. A first method is to provide an absolute value. A second method is to provide a relative value. The second method may be used for updating the NAM.

The application layer provides downward QoS information related to media characteristics with respect to a lower layer. Two types of downward information such as an MMT asset level information and packet level information exist. The MMT asset information is used to exchange capacity and/or (re)allocate resource in a lower layer. Packet level downward information is recorded in an appropriate field of every packet for a lower layer in order to discriminate supported QoS level.

The lower layer provides upward QoS information to the application layer. The lower layer provides information which allows for fast and accurate QoS control and is related to a network state changing over time. The upward information is expressed in an abstracted form to support a heterogeneous network environment. Such parameters are measured in a lower layer and read in an application layer periodically or according to a request from an MMT application.

Hereinafter, an indicator indicating information that may be provided by a media encoder in relation to media data in a system for transmitting coded media data via a heterogeneous IP network will be described.

### Embodiment #1

A method of transporting coded media fragment data via a heterogeneous IP network according to an embodiment of the present invention may be performed as illustrated in FIG. 6. According to the method of transporting coded media fragment data according to an embodiment of the present invention, a media unit (MU) having a format independent on a particular media codec is received from a media codec layer (S610). The provided media unit is encapsulated to generate an MMT asset (S620). As mentioned above, the MMT asset is encapsulated to generate an MMT package (S630), an MMT payload format is generated upon receiving the MMT package (S640), and an MMT transport packet is generated upon receiving an MMT payload format (S650).

In an embodiment of the present invention, information obtained by an encoder during an encoding operation may be delivered to a system by including a plurality of indicators in a media unit. Hereinafter, a specific embodiment will be described. An indicator, which is minimum information that may be provided by the media encoder and is generated by the encoder in the media unit in relation to media data includes a flag RAP indicating a random access point (RAP) and a flag_start_media and flag_end_media indicating start and end of coded media data, and in addition, includes flag_lossless indicator expressing whether or not the coded media fragment data is critical when transmitted. Here, whether or not the coded media fragment data is critical indicates whether or not the coded media fragment data may cause a serious problem when processed in a decoder when a bit or a packet of the coded media fragment data is lost in case of transmitting the media unit is transmitted. Namely, when the flag_lossless indicator indicates critical, it indicates that corresponding data has very low loss tolerance. Some of the respective indicators as mentioned above may be omitted as necessary.

Hereinafter, the respective indicators will be described in detail.

flag_RAP is an indicator indicating whether or not the coded media fragment data has a random access point (RAP). When a value of the Flag_RAP indicator is 1, it indicates that the coded media fragment data includes a start point available for a random access. Conversely, when the value of the Flag_RAP indicator is 0, it indicates that the coded media fragment data does not have a start point available for a random access.

flag_start_of_media is an indicator indicating whether or not the coded media fragment data has a first fragment of coded media data sharing the same PTS (presentation time stamp). When a value of the flag_start_of_media indicator is 1, it indicates that the coded media fragment data included in a corresponding media unit has a first fragment of the coded media data sharing the same PTS. In a similar manner, when the value of the flag_start_of_media is not 1, it indicates that a fragment of the coded media fragment data included in a corresponding media unit is not a first fragment of the coded media data sharing the same PTS.

flag_end_of_media is an indicator indicating whether or not the coded media fragment data included in the corresponding media unit has a final fragment of the coded media data sharing the same PTS. Namely, when a value of flag_end_of_media is 1, it indicates that the coded media fragment data included in the corresponding media unit has a final fragment of the coded media data sharing the same PTS.

According to an embodiment of the present invention, an indicator value of a media unit including single coded media data without being fragmented is flag_start_of_media==1 and flag_end_of_media==1.

flag_lossless is an indicator indicating whether or not coded media fragment data included in a corresponding media unit is critical to a loss of a bit or a packet. When a value of the flag_lossless indicator is 1, it indicates that the coded media fragment data includes data that may cause a serious problem in a decoding process of a decoder when a bit or a packet is lost.

### Embodiment #2

A method of transporting coded media fragment data via a heterogeneous IP network according to another embodiment of the present invention may be performed as illustrated in FIG. 7. The method of transporting coded media fragment data according to an embodiment of the present invention starts from receiving a media processing unit (MPU) having a format independent on a particular media codec from a media codec layer (S710). The provided media processing unit is encapsulated to generate an MMT asset (S720). As mentioned above, the MMT asset is encapsulated to generate an MMT package (S730), an MMT payload format is generated upon receiving the MMT package (S740), and an MMT transport packet is generated upon receiving an MMT payload format (S750).

In an embodiment of the present invention, information obtained by an encoder during an encoding operation may be delivered to a system by including a plurality of indicators in a media processing unit (MPU). Hereinafter, a specific embodiment will be described.

In an embodiment of the present invention, a media processing unit (MPU) includes a header part and a data part. The data part includes a coded media fragment data. The header part includes a flag_RAP indicator indicating whether or not the coded media fragment data includes a random access point, a flag_start_of_media indicator indicating whether or not the coded media fragment data includes a start portion of coded media data, a flag_end_of_media indicator indicating whether or not the coded media fragment data includes a final portion of the coded media data, and a flag_lossless indicator indicating whether or not the coded media fragment data requests lossless transmission.

A process of generating an MPU according to an embodiment of the present invention will be described. In an embodiment of the present invention, coded media data is fragmented into coded media fragment data. During the fragmentation, a sequence number of the coded media fragment data. Or, the coded media fragment data may be sequentially inserted in to an MPU without generating a sequence number of the coded media fragment data. Whether or not the coded media fragment data is a first coded media fragment data or a final coded media fragment data during an encoding process and whether or not the coded media fragment data has a random access point may be determined.

The first coded media fragment data is separated from the coded media data. Whether or not the separated coded media fragment data has a random access point, and the separated coded media fragment data is inserted to the MPU. Since the data is coded media fragment data, a sequence number of the generated coded media fragment data is stored in the frag_start_media. In another embodiment of the present invention, when the sequence number of the coded media fragment data is not generated, a relative position in which the coded media fragment data is inserted in the MPU is stored. And then, whether or not it has a random access point is indicated in the flag_RAP. In an embodiment of the present invention, the flag_RAP indicator may accommodate sequence numbers of the coded media fragment data. In another embodiment of the present invention, based on a relative position in which the coded media fragment data is inserted in the MPU, when the flag_RAP is a bslbf (bit string, left bit first) indicator by which a left bit has priority, if the generated coded media fragment data has a random access point, 1 is stored in a first bit of flag_RAP and when the coded media fragment data does not have a random access point, 0 is stored in the first bit. In a similar manner, a lossless_flags value may be maintained.

The foregoing process is repeatedly performed on next coded media fragment data of the coded media data. When generated coded media fragment data is final coded media fragment data of the coded media data, a sequence number of the generated coded media fragment data in flag_end_of_media of the MPU. And, when encoding on all of the coded media fragment data of the coded media data is terminated, encapsulating of the MPU is terminated.

### Embodiment #3

A method of transporting coded media fragment data via a heterogeneous IP network according to another embodiment of the present invention may be performed as illustrated in FIG. 8. According to the method of transporting coded media fragment data according to an embodiment of the present invention, a media fragment unit (MFU) having a format independent on a particular media codec is received from a media codec layer (S810). The provided media fragment unit is encapsulated to generate a media processing unit (MPU) (S820). The media processing unit is encapsulated to generate an MMT asset (S830). As mentioned above, the MMT asset is encapsulated to generate an MMT package (S840), an MMT payload format is generated upon receiving the MMT package (S850), and an MMT transport packet is generated upon receiving an MMT payload format (S860).

In an embodiment of the present invention, information obtained by an encoder during an encoding operation may be delivered to a system by including a plurality of indicators in a media fragment unit (MFU). Hereinafter, a specific embodiment will be described.

An example in which an indicator provided by the media encoder as mentioned above in the MFU is applied will be described. The foregoing media fragment unit (MFU) may be used as an output of the media encoder (e.g., a video encoder or an audio encoder). An MFU according to an embodiment of the present invention is illustrated in FIG. 4. The MFU may include an MFU header (mfu_header) field as a header part and a media data (media_data) field as a data part.

According to an embodiment of the present invention, an access unit is divided into one or more coded media fragment data and the respective portions are separately accommodated in respective MFUs. The separated AU data is accommodated in the media data (media_data) field of each MFU. A header structure of the MFU according to an embodiment of the present invention is illustrated in FIG. 5. An MFU header (mfu_header) field may be used as a passage for delivering information to a system, such that the media encoder creates content and hands it over to the system.

Hereinafter, syntax and semantics of an MFU header according to an embodiment of the present invention will be described. According to an embodiment of the present invention, an MFU header may be designed to have a size fixed to a single byte for simplicity. Namely, the size of an MFU header may be limited to a single byte for simplicity.

Also, in order for the MFU header to be used in most media codecs and in order to avoid dependency to a media codec of a particular category, a header of an MFU may include minimum information that can be provided by the media encoder. Thus, the MFU header according to an embodiment of the present invention has a minimized size and simplified structure. Generation of the MFU is not processed by the system but accessed/processed by the media encoder. Thus, if the MFU header has a complicated structure, its implementation is not easy and availability thereof is degraded. Also, the MFU header is configured to have general information that may help media transmission and consumption, namely, information best known by the media encoder. Also, in configuring the MFU header, information dependent on particular media or a particular media codec is excluded as possible.

A structure of an MFU header will be described in detail with reference to FIG. 5. As illustrated in FIG. 5, an MFU header according to an embodiment of the present invention may include indicators flag_RAP, flag_lossless, flag_start_of_AU, and flag_end_of_AU, and reserved as a reserved area. In order to express the four indicators within 1 byte, the indicators flag_RAP, flag_lossless, flag_start_of_AU, and flag_end_of_AU are designed to occupy a 1-bit space. And, for later usage extendibility, a 4-bit reserved area may be provided. Each indicator may be omitted as necessary.

Hereinafter, the indicators will be described in detail.

flag_RAP is an indicator indicating whether or not the coded media fragment data included in an MFU has a random access point (RAP). When a value of the Flag_RAP indicator is 1, it indicates that the coded media fragment data includes a start point available for a random access. Conversely, when the value of the Flag_RAP indicator is 0, it indicates that the coded media fragment

flag_lossless is an indicator indicating whether or not media data included in the MFU is critical to a loss of a bit or a packet. When a value of the flag_lossless indicator is 1, it indicates that the coded media fragment data included in the corresponding MFU includes data that may cause a serious problem in a decoding process of a decoder when a bit or a packet is lost.

flag_start_of_AU is an indicator indicating whether or not the coded media fragment data included in the corresponding MFU has a first fragment of an access unit (AU) sharing the same PTS (presentation time stamp). When a value of the flag_start_of_AU indicator is 1, it indicates that the coded media fragment data included in the corresponding MFU has a first fragment of the coded media data sharing the same PTS. In a similar manner, when the value of the flag_start_of_AU is not 1, it indicates that a fragment of the coded media fragment data included in the corresponding MFU is not a first fragment of the AU sharing the same PTS.

flag_end_of_AU is an indicator indicating whether or not the coded media fragment data included in the corresponding MFU has a final fragment of the AU sharing the same PTS. Namely, when a value of flag_end_of_AU is 1, it indicates that the coded media fragment data included in the corresponding MFU has a final fragment of the AU sharing the same PTS. In an embodiment of the present invention, a value of an indicator of an MFU including a single AU without being fragmented is flag_start_of_AU==1 and flag_end_of_AU==1.

The MFU generated in the foregoing embodiment is sequentially stored in the MPU and media data may be transmitted without the necessity of assigning an MFU sequence number. Since an MFU sequence number is not assigned, a size of data to be transmitted can be reduced. An MFU sequence number, a sequence number of an MFU, is defined to identify an MFU in one MPU.

An operation of a decoder when an MFU sequence number is not assigned will be described. A decoder of a receiver decapsulates a received MPU in reception order to obtain MFU sequentially stored in an MPU. The decoder recognizes a random access start point and a start and an end of media data with reference to a header of the MFU. In case of an MFU having data that may cause a serious problem to a decoder process in the occurrence of a bit or a packet, a retransmission may be requested or the decoding operation may be omitted.

In another embodiment of the present invention, an MFU sequence number indicating a precedence relationship of separated AU fragments may be indicated by generating a separate field in an MFU. A separate MFU sequence number field may be used in an MFU header (mfu_header). Or, an MFU sequence number may be stored in every MFU by using a separate MFU sequence number field in addition to a MFU header (mfu_header) field and a media data (media_data) field in an MFU. Or, an MFU sequence number may be included in a particular portion of a media data (media_data) field in which coded media fragment data is accommodated. An encoder and a decoder may guarantee agreement of order between media data and an MFU by using an MFU sequence number.

### Embodiment #4

A method of transporting coded media fragment data via a heterogeneous IP network according to another embodiment of the present invention may be performed as illustrated in FIG. 8. According to the method of transporting coded media fragment data according to an embodiment of the present invention, a media fragment unit (MFU) having a format independent on a particular media codec is received from a media codec layer (S810). The provided media fragment unit is encapsulated to generate a media processing unit (MPU) (S820). The media processing unit is encapsulated to generate an MMT asset (S830). As mentioned above, the MMT asset is encapsulated to generate an MMT package (S840), an MMT payload format is generated upon receiving the MMT package (S850), and an MMT transport packet is generated upon receiving an MMT payload format (S860).

In an embodiment of the present invention, information obtained by an encoder during an encoding operation may be delivered to a system by including a plurality of indicators in a media processing unit (MPU). Hereinafter, a specific embodiment will be described.

In another embodiment of the present invention, only coded media fragment data may be stored in an MFU, MFUs may be sequentially stored in an MPU, MFUs corresponding to first coded media fragment data and a final coded media fragment data of an AU may be indicated in a header of the MPU, and an MFU corresponding to coded media fragment data having a start point of a random access may be indicated.

In another embodiment of the present invention, the coded media fragment data and the MFU sequence number are stored in the MFU, MFUs corresponding to first coded media fragment data and a final coded media fragment data of an AU may be indicated in a header of the MPU, and an MFU corresponding to coded media fragment data having a start point of a random access may be indicated.

Another embodiment of the present invention will be described in more detail. In another embodiment of the present invention, an MFU includes an MFU sequence number and coded media fragment data. The MFU may also include Subsample_start_id, Subsample_end_id, and RAP_flags indicators.

Subsample_start_id and Subsample_end_id specify a range of MFUs of a corresponding AU. mfu_sequence_id specified by Subsample_start_id indicates an MFU sequence number of a first MFU among MFUs belonging to the corresponding AU. mfu_sequence_id specified by Subsample_end_id indicates a final MFU sequence number of MFUs belonging to the corresponding AU.

RAP_flags indicates whether or not the corresponding AU has a random access point (RAP0. When the AU has an RAP, RAP_flags may have a value 1. This may be implemented such that MFUs belonging to an MPU have a bit 0 or 1 in continuous relative order and whether or not each MFU has a certain RAP is indicated. When even one of MFUs belonging to one AU has a random access point, RAP_flags has a value not 0, and all of the MFUs do not have a random access point, RAP_flags has a value 0. Or, RAP_flags may accommodate an MFU sequence number.

The MPU may include Lossless_flags indicating whether or not each MFU is critical data that may cause a serious problem in processing of a decoder when a bit or a packet is lost, in the same manner as that of the RAP_flags. When the AU has critical data, Lossless_flags may have a value 1. MFUs belonging to an MPU may have a value of bit 1 or 0 in continuous order to indicate whether or not each MFU has critical data. Even one of MFUs belonging to one AU has critical data, Lossless_flags has a value not 0, and all of the MFUs do not have a random access point, Lossless_flags has a value 0.

Whether or not an MFU has critical data may be indicated in an MMT asset level or in an MMT transport packet level, rather than an MFU level. A request for lossless transmission may be indicated for one asset while indicating whether or not a data loss is allowed in an MMT asset level, or lossless transmission of a transmitted packet may be requested, while indicating whether or not a data loss is allowed in an MMT transport packet level.

1. A method of transporting coded media data in a system for transporting coded media fragment data via a heterogeneous IP network, the method comprising:
receiving a media unit (MU) having a format independent on a particular media codec from a media codec layer;
generating an MMT asset by encapsulating the generated media unit;
generating an MMT package by encapsulating the generated MMT asset;
generating an MMT payload format upon receiving the generated MMT package; and
generating an MMT transport packet upon receiving the generated MMT payload format,
wherein the media unit includes a header part and a data part, the data part includes coded media fragment data, and the header part includes an indicator indicating whether or not the coded media fragment data includes a random access point, an indicator indicating whether or not the coded media fragment data includes a start portion of coded media data, and an indicator indicating whether or not the coded media fragment data includes a final portion of the coded media data.

2. The method of claim 1, wherein the header part further includes an indicator indicating whether or not the coded media fragment data requests lossless transmission.

3. The method of claim 1, wherein the receiving of the MU having a format independent on a particular media codec from the media codec layer is receiving a media processing unit (MPU) having a format independent on a particular media codec from the media codec layer, and
the generating of an MMT asset by encapsulating the generated MU is generating an MMT asset by encapsulating the generated MPU.

4. The method of claim 1, wherein the header part includes an indicator indicating whether or not the coded media fragment data includes a random access point, an indicator indicating whether or not the coded media fragment data includes a start portion of an access unit (AU), and an indicator indicating whether or not the coded media fragment data includes a final portion of the AU.

5. A method of transporting coded media data in a system for transporting coded media fragment data via a heterogeneous IP network, the method comprising:
receiving a media fragment unit (MFU) having a format independent on a particular media codec from a media codec layer;
generating a media processing unit (MPU) by encapsulating the MFU;
generating an MMT asset by encapsulating the generated MPU;
generating an MMT package by encapsulating the generated MMT asset;
generating an MMT payload format upon receiving the generated MMT package; and
generating an MMT transport packet upon receiving the generated MMT payload format,
wherein the media unit includes a header part and a data part, the data part includes coded media fragment data, and the header part includes an indicator indicating whether or not the coded media fragment data includes a random access point, an indicator indicating whether or not the coded media fragment data includes a start portion of coded media data, and an indicator indicating whether or not the coded media fragment data includes a final portion of the coded media data.

6. The method of claim 5, wherein the header part further includes an indicator indicating whether or not the coded media fragment data requests lossless transmission.

7. The method of claim 6, wherein the header part includes an indicator indicating whether or not the coded media fragment data includes a random access point, an indicator indicating whether or not the coded media fragment data includes a start portion of an access unit (AU), and an indicator indicating whether or not the coded media fragment data includes a final portion of the AU.

8. The method of claim 7, wherein the header part further includes an indicator indicating whether or not the coded media fragment data requests lossless transmission.
